(19) United States
(12) Patent Application Publication
(10) Pub. No.: US 2026/0307217 A1
(43) Pub. Date: Oct. 8, 2026

(54) OPEN-END WRENCH STRUCTURE

(71) Applicant: INFAR INDUSTRIAL CO., LTD., CHANG-HWA (TW)

(72) Inventor: Tai-Hung CHEN, CHANG-HWA (TW)

(21) Appl. No.: 19/171,207

(22) Filed: Apr. 5, 2025

(51) Int. Cl. B25B 13/08

(52) U.S. Cl. CPC B25B 13/08

(57) ABSTRACT

An open-end wrench structure includes a handle portion and a driving portion connected to the handle portion. The wrench is characterized by a first extension line (L1), a second extension line (L2), a drive axis (L3), a first intersection point (P1), a second intersection point (P2), a third intersection point (P3), a first connection line (C1), a second connection line (C2), a pulling angle (θ_pull), a resisting angle (θ_resist), and a concave arc angle (θ_arc), which satisfy: 35°<θ_pull<70°; 45°<θ_resist<95°; θ_pull<θ_arc; θ_resist<θ_arc; and P2 and P3 are outside a region bounded by L1 and L2. These features enhance structural strength and torque capacity.

### BACKGROUND

### Field of the Invention

The present invention relates to a hand tool, and more particularly to an open-end wrench structure.

### Description of Related Art

As a common hand tool, the open-end wrench plays an indispensable role in mechanical assembly, maintenance, and daily life. The main function of the open-end wrench is to quickly and accurately apply torque, thereby enabling the installation and removal of screws or bolts. Moreover, its open-end design enables the wrench to be quickly inserted by or removed from the bolt head, significantly improving work efficiency. The open-end wrench is especially suitable for situations where the orientation of tool needs to be frequently changed or where multiple bolts need to be dealt with.

The core of the open-end wrench lies in the design of its open-end driving portion. This part directly contacts the bolt head or nut and effectively transmits the torque applied by the user to the driven element. A poorly designed open-end driving portion may lead to slippage, damage to the bolt, or even safety accidents. Therefore, it is of great significance to provide an open-end wrench structure with high structural precision and durability.

### SUMMARY

An objective of the present invention is to provide an open-end wrench structure capable of solving one of the above-mentioned problems.

To achieve the above-mentioned objective, the present invention provides an open-end wrench structure, which comprises: a handle portion having a first connecting arc surface and a second connecting arc surface opposing the first connecting arc surface; and a driving portion connected to the handle portion, the driving portion including: an outer contour surface segment concurrently adjoining the first connecting arc surface and the second connecting arc surface; a first driving surface connected to a first end of the outer contour surface segment; a second driving surface connected to a second end of the outer contour surface segment and facing the first driving surface; and a concave arc surface connected to and located between the first driving surface and the second driving surface, wherein the first driving surface, the second driving surface, and the concave arc surface collectively form a drive opening; wherein: a first extension line is defined by a line linearly extending along and from the first driving surface toward the handle portion; a second extension line is defined by a line linearly extending along and from the second driving surface toward the handle portion; a drive axis equidistantly at a distance from the first extension line and the second extension line is defined; the drive axis intersects the concave arc surface at a first intersection point; a second intersection point is defined at a point in an intersection line between the first connecting arc surface and the outer contour surface segment; a third intersection point is defined at a point in an intersection line the second connecting arc surface and the outer contour surface segment; a first connection line is defined by a straight line passing through the first intersection point and the second intersection point; a second connection line is defined by a straight line passing through the first intersection point and the third intersection point; a pulling angle is defined by an angle between the first connection line and the drive axis; a resisting angle is defined by an angle between the second connection line and the drive axis; the concave arc surface includes a concave arc angle; and the following conditions are satisfied: 35°<θ_pull<70°; 45°<θ_resist<95°; θ_pull<θ_arc; and θ_resist<θ_arc; and the second intersection point and the third intersection point are positioned outside a region bounded by the first extension line and the second extension line.

Advantages of the present invention: when the above conditions (namely, 35°<θ_pull<70°; 45°<θ_resist<95°; θ_pull<θ_arc; θ_resist<θ_arc; and the second intersection point and the third intersection point are positioned outside a region bounded by the first extension line and the second extension line) are satisfied, the structural strength of the driving portion of the open-end wrench structure is enhanced, enabling the wrench to deliver maximum torque.

Preferably, the driving portion includes a maximum width, and the second intersection point and the third intersection point are located within a coverage defined bt the maximum width.

### BRIEF DESCRIPTION OF THE DRAWINGS

FIG. 1 is a perspective view of an embodiment of the present invention; and

FIG. 2 is a top view of a part of the embodiment of the present invention.

### DETAILED DESCRIPTION

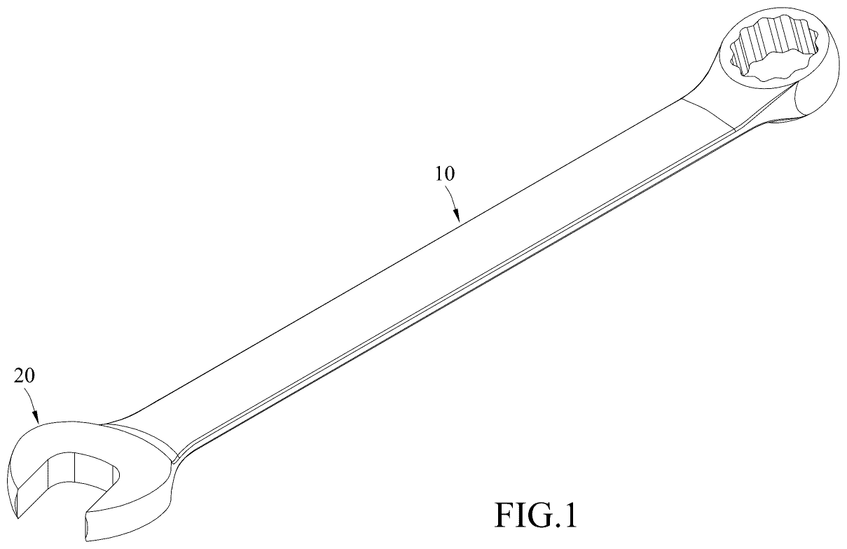

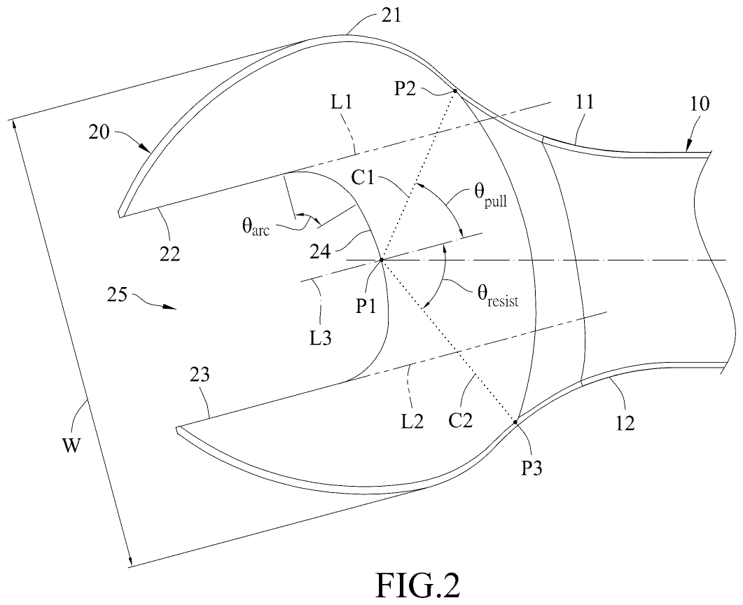

With reference to FIGS. 1 and 2, an open-end wrench structure according to a first embodiment of the present invention comprises a handle portion (10) and a driving portion (20).

The handle portion (10) is configured to be gripped and manipulated by a user and includes a first connecting arc surface (11) and a second connecting arc surface (12) opposing the first connecting arc surface (11). In this embodiment, the first connecting arc surface (11) and the second connecting arc surface (12) are oppositely recessed.

The driving portion (20) is connected to the handle portion (10) and configured to rotate a driven element. The driving portion (20) includes: an outer contour surface segment (21) adjoining the first connecting arc surface (11) and the second connecting arc surface (12); a first driving surface (22) connected to a first end of the outer contour surface segment (21); a second driving surface (23) connected to a second end of the outer contour surface segment (21) and facing the first driving surface (22); and a concave arc surface (24) connected to and located between the first driving surface (22) and the second driving surface (23). The first driving surface (22), second driving surface (23), and concave arc surface (24) collectively form a drive opening (25).

A critical inventive aspect of the present invention resides in the following geometric configuration. A first extension line (L1) is defined by a line linearly extending along and from the first driving surface (22) toward the handle portion (10); and a second extension line (L2) is defined by a line linearly extending along and from the second driving surface (23) toward the handle portion (10), and the second extension line (L2) is parallel to the first extension line (L1).

A drive axis (L3) equidistantly at a distance from the first extension line (L1) and the second extension line (L2) is defined, namely that a perpendicular distance from the drive axis (L3) to the first extension line (L1) is equal to a perpendicular distance from the drive axis (L3) to the second extension line (L2). The drive axis (L3) intersects the concave arc surface (24) at a first intersection point (P1).

A second intersection point (P2) is defined at a point in an intersection line between the first connecting arc surface (11) and the outer contour surface segment (21). It is noted that the second intersection point (P2) is an endpoint of an intersection line between the first connecting arc surface (11) and the outer contour surface segment (21).

A third intersection point (P3) is defined at a point in an intersection line the second connecting arc surface (12) and the outer contour surface segment (21). Similarly, the third intersection point (P3) is an endpoint of a linear boundary formed by the intersection of the second connecting arc surface (12) and the outer contour surface segment (21).

A first connection line (C1) is defined by a straight line passing through the first intersection point (P1) and the second intersection point (P2). A second connection line (C2) is defined by a straight line passing through the first intersection point (P1) and the third intersection point (P3).

A pulling angle (θ_pull) is defined by an angle between the first connection line (C1) and the drive axis (L3). A resisting angle (θ_resist) is defined by an angle between the second connection line (C2) and the drive axis (L3). The concave arc surface (24) includes a concave arc angle (θ_arc). In this embodiment, θ_arc=74°, and the following conditions are satisfied.

The pulling angle (θ_pull) is 52°, though not limited thereto. The pulling angle (θ_pull) may range between 35° and 70°.

The resisting angle (θ_resist) is 67°, though not limited thereto. The resisting angle (θ_resist) may range between 45° and 95°.

As is evident from the foregoing, the pulling angle (θ_pull) and the resisting angle (θ_resist) are different not much. Furthermore, the two angles are intentionally designed to be smaller than the concave arc angle (θ_arc).

The second intersection point (P2) and third intersection point (P3) are positioned outside a region bounded by the first extension line (L1) and the second extension line (L2).

Additionally, the driving portion (20) has a maximum width (W), and the second intersection point (P2) and third intersection point (P3) are located within a coverage defined by this maximum width (W). The coverage defined by the maximum width (W) is a regional space between two tangent lines (or planes) at two opposite points in the outer contour surface segment (21) of the driving portion (20), and the minimum (straight line) distance between the two opposite points (or planes) is the maximum width (W).

The design constraint, 35°<θ_pull<70°, achieves the following technical effects: enhanced operational efficiency of the open-end wrench structure; reduced attrition during use; continuous operation capability in confined spaces to minimize an angle by which the open-end wrench structure needs to be rotated; and rapid manipulation in tight spaces where only limited wrench movement is feasible.

The design constraint, 45°<θ_resist<95°, achieves the following technical effects: maximized stability during torque transmission; prevention of slippage or damage to the fastener head; increased effective contact area between the driving portion (20) and a fastener; uniform torque distribution over contact regions; and mitigation of localized stress concentration.

The synergistic combination of: the angular ranges of the pulling angle θ_pull and resisting angle θ_resist; and the requirements that both the pulling angle θ_pull and resisting angle θ_resist are smaller than θ_arc and the second intersection point P2 and third intersection point P3 are located outside the L1-L2 boundary region, collectively ensures: secure engagement between the wrench and the driven element; prevention of slippage due to insufficient resistance; stable and precise torque transmission under high-load conditions; improved safety and durability of the wrench and driven element; and enhanced structural strength of the driving portion (20) to maximize torque.

What is claimed is:

1. An open-end wrench structure comprising:
a handle portion having a first connecting arc surface and a second connecting arc surface opposing the first connecting arc surface; and
a driving portion connected to the handle portion, the driving portion including: an outer contour surface segment adjoining the first connecting arc surface and the second connecting arc surface; a first driving surface connected to a first end of the outer contour surface segment; a second driving surface connected to a second end of the outer contour surface segment and facing the first driving surface; and a concave arc surface connected to and located between the first driving surface and the second driving surface,
wherein the first driving surface, the second driving surface, and the concave arc surface collectively form a drive opening; a first extension line is defined by a line linearly extending along and from the first driving surface toward the handle portion; a second extension line is defined by a line linearly extending along and from the second driving surface toward the handle portion; a drive axis equidistantly at a distance from the first extension line and the second extension line is defined; the drive axis intersects the concave arc surface at a first intersection point; a second intersection point is defined at a point in an intersection line between the first connecting arc surface and the outer contour surface segment; a third intersection point is defined at a point in an intersection line between the second connecting arc surface and the outer contour surface segment;
a first connection line is defined by a straight line passing through the first intersection point and the second intersection point; a second connection line is defined by a straight line passing through the first intersection point and the third intersection point; a pulling angle is defined by an angle between the first connection line and the drive axis; a resisting angle is defined by an angle between the second connection line and the drive axis; the concave arc surface includes a concave arc angle; the following conditions are satisfied:
35°<θ_pull<70°;
45°<θ_resist<95°;
θ_pull<θ_arc; and
θ_resist<θ_arc; and
the second intersection point and the third intersection point are positioned outside a region bounded by the first extension line and the second extension line.

2. The open-end wrench structure as claimed in claim 1, wherein the driving portion has a maximum width; and the second intersection point and the third intersection point are located within a coverage defined by the maximum width.
